(19) United States
(12) Patent Application Publication
(10) Pub. No.: US 2025/0197232 A1
(43) Pub. Date: Jun. 19, 2025

(54) Sodium-based Cation-Disordered Rock Salts for High-Performance Na-Ion Battery Cathodes

(71) Applicant: UNM RAINFOREST INNOVATIONS, Albuquerque, NM (US)

(72) Inventors: Dongchang CHEN, Albuquerque, NM (US); Alexandra OUTKA, Albuquerque, NM (US); Basirat RAJI-ADEFILA, Albuquerque, NM (US); You WANG, Albuquerque, NM (US)

(21) Appl. No.: 18/978,477

(22) Filed: Dec. 12, 2024

Related U.S. Application Data
(60) Provisional application No. 63/609,472, filed on Dec. 13, 2023.

(51) Int. Cl. C01D 1/02; H01M 10/054

(52) U.S. Cl. CPC C01D 1/02; H01M 10/054; C01P 2002/72; C01P 2006/40

(57) ABSTRACT

A cathode for an electrochemical device is described including a sodium-based disordered rock salt which can include a transition metal, such as manganese, iron, or titanium. The electrochemical device can be a sodium-ion battery. The disordered rock salt can either be stoichiometric or an over-stoichiometric. A degree of over-stoichiometry of the disordered rock salt is from 0% to about 100%. The disordered rock salt may include, Na_{1.1}Ti_{0.2}Mn_{0.7}O₂, MS10-Na_{1.1}Ti_{0.2}Mn_{0.7}O₂, MS20-Na_{1.1}Ti_{0.2}Mn_{0.7}O₂, Na_{1.2}Ti_{0.4}Mn_{0.4}O₂, MS10-Na_{1.2}Ti_{0.4}Mn_{0.4}O₂, Na_{1.3}Ti_{0.6}Mn_{0.1}O₂, and MS10-Na_{1.3}Ti_{0.6}Mn_{0.1}O₂, or a combination thereof.

### REFERENCE TO RELATED APPLICATIONS

This application claims the benefit of U.S. Provisional Patent Application No. 63/609,472, filed on Dec. 13, 2023, which is hereby incorporated by reference in its entirety.

### TECHNICAL FIELD

The present teachings relate generally to energy storage devices and, more particularly, to earth-abundant cation-disordered rock salts for use in rechargeable battery cathodes.

### BACKGROUND

Na-ion batteries have been considered as the most suitable choice for both stationary energy storage facilities and electrical vehicles, owing to the practically unlimited natural resource of Na.

In the past decade, lithium-based cation-disordered rock salts have been found as a class of high-performance cathode materials when applied in lithium-ion batteries. These lithium-based cation-disordered rock salts include both stoichiometric ones, in which the mole ratio of total cations to anions is equal to 1, and over-stoichiometric ones, in which the mole ratio of total cations to anions is greater than 1.

Considering the advantage of Na-ion batteries and similarity in chemical properties between lithium and sodium ions, it is desirable to develop sodium-based cation-disordered rock salt, including both stoichiometric and over-stoichiometric ones. Moreover, on the basis of materials development, it is an important task to determine their ability to perform as Na-ion battery cathodes. Such technologies are ideally suited to fulfill the need of inexpensive and energy-dense battery technologies and hold promise to reach the goal of net-zero emission.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A cathode for an electrochemical device is disclosed. The cathode for an electrochemical device includes a disordered rock salt which may include a transition metal. The cathode for an electrochemical device includes where the sodium-based cation-disordered rock salt has a chemical formula of Naₐ₊ₓM_{b}O_{2-y}F_{y}, and wherein a≥1, 0≤x≤1.0*(a+b), y≥0, and M comprises a transition metal selected from the group consisting of titanium, vanadium, chromium, manganese, iron, cobalt, nickel, zirconium, niobium, molybdenum, ruthenium, tantalum, and tungsten. The cathode for an electrochemical device can include wherein the sodium-based cation-disordered rock salt can either be stoichiometric (x=0 and a+b=2) or over-stoichiometric (a+b+x>2 and x>0). The cathode can include where the sodium-based cation-disordered rock salt is over-stoichiometric and the over-stoichiometry amount of sodium comprises an extra mole ratio of sodium of between 0% and about 100%. The cathode can include wherein the sodium-based cation-disordered rock salt is selected from the group consisting of Na_{1.1}Ti_{0.2}Mn_{0.7}O₂, MS10-Na_{1.1}Ti_{0.2}Mn_{0.7}O₂, MS20-Na_{1.1}Ti_{0.2}Mn_{0.7}O₂, Na_{1.2}Ti_{0.4}Mn_{0.4}O₂, MS10-Na_{1.2}Ti_{0.4}Mn_{0.4}O₂, Na_{1.3}Ti_{0.6}Mn_{0.1}O₂, and MS10-Na_{1.3}Ti_{0.6}Mn_{0.1}O₂. The sodium-based cation-disordered rock salt can be in a metastable state.

A sodium-ion battery is disclosed, the battery including a cathode having a cation-disordered rock salt including sodium and at least one transition metal, and an anode, and wherein the cation-disordered rock salt is over-stoichiometric. The sodium-ion battery can include where the cation-disordered rock salt has a chemical formula of Naₐ₊ₓM_{b}O_{2-y}F_{y}, wherein a≥1, 0≤x≤1.0*(a+b), y≥0, and M comprises a transition metal selected from the group consisting of titanium, vanadium, chromium, manganese, iron, cobalt, nickel, zirconium, niobium, molybdenum, ruthenium, tantalum, and tungsten. The sodium-ion battery can include where the cation-disordered rock salt can either be stoichiometric (x=0) or over-stoichiometric (x>0). The sodium-ion battery can include where the cation-disordered rock salt is over-stoichiometric and the over-stoichiometry amount of sodium comprises an extra mole ratio of sodium of between 0% and about 100%. The sodium-ion battery can include where the cation-disordered rock salt is selected from the group consisting of Na_{1.1}Ti_{0.2}Mn_{0.7}O₂, MS10-Na_{1.1}Ti_{0.2}Mn_{0.7}O₂, MS20-Na_{1.1}Ti_{0.2}Mn_{0.7}O₂, Na_{1.2}Ti_{0.4}Mn_{0.4}O₂, MS10-Na_{1.2}Ti_{0.4}Mn_{0.4}O₂, Na_{1.3}Ti_{0.6}Mn_{0.1}O₂, and MS10-Na_{1.3}Ti_{0.6}Mn_{0.1}O₂. The sodium-ion battery can include where the cation-disordered rock salt is in a metastable state.

A method of synthesizing a cation-disordered rock salt cathode for a sodium-ion battery is disclosed, which includes the steps of providing at least one compound comprising sodium, providing at least one compound comprising a transition metal, mixing the compound comprising sodium and the compound comprising a transition metal, and producing a cation-disordered rock salt cathode. The method can include where the mixing is performed with a mechanochemical method. The method can include where the mixing is performed with a planetary ball mill operating at or above 300 rpm. The method can include where the cation-disordered rock salt cathode has a chemical formula of Naₐ₊ₓM_{b}O_{2-y}F_{y}, and wherein a≥1, 0≤x≤1.0*(a+b), y≥0, and M comprises a transition metal selected from the group consisting of titanium, vanadium, chromium, manganese, iron, cobalt, nickel, zirconium, niobium, molybdenum, ruthenium, tantalum, and tungsten. The method can include where the cation-disordered rock salt can either be stoichiometric (x=0) or over-stoichiometric (x>0), or where the cation-disordered rock salt is over-stoichiometric and the over-stoichiometry amount of sodium comprises an extra mole ratio of sodium of between 0% and about 100%. The method can include where the stoichiometric cation-disordered rock salt has a mole ratio of total cations to total anions being equal to 1:1, and the over-stoichiometric sodium-based cation-disordered rock salt has a mole ratio of total cations to total anions being greater than 1:1. The method can include the step of incorporating the cation-disordered rock salt cathode into a sodium-ion battery.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts the likely structure of stoichiometric and over-stoichiometric sodium-based cation-disordered rock salts, in accordance with the present disclosure.

FIG. 2 is a diagram depicting compositional difference between stoichiometric and over-stoichiometric sodium-based cation-disordered rock salts, in accordance with the present disclosure.

FIG. 3 is a flow chart of a first exemplary method of synthesizing a sodium-based cation-disordered rock salt cathode, in accordance with the present disclosure.

FIG. 4 is a graph of X-ray diffraction patterns of the stoichiometric Na-excess cation-disordered rock salt cathode (Na_{1.1}Ti_{0.2}Mn_{0.7}O₂), and the over-stoichiometric 10% extra mole ratio (hereafter MS10) Na-excess cation-disordered rock salt cathode (MS10-Na_{1.1}Ti_{0.2}Mn_{0.7}O₂), and 20% extra mole ratio (hereafter MS20) Na-excess cation-disordered rock salt cathode (MS20-Na_{1.1}Ti_{0.2}Mn_{0.7}O₂), in accordance with the present disclosure.

FIG. 5 is a graph of the electrochemical performance of Na_{1.1}Ti_{0.2}Mn_{0.7}O₂, MS10-Na_{1.1}Ti_{0.2}Mn_{0.7}O₂, and MS20-Na_{1.1}Ti_{0.2}Mn_{0.7}O₂ in the first cycle under the current density of 10 mA g⁻¹, in accordance with the present disclosure.

FIGS. 6A, 6B, and 6C are graphs of the electrochemical performance of Na_{1.1}Ti_{0.2}Mn_{0.7}O₂ (FIG. 6A), MS10-Na_{1.1}Ti_{0.2}Mn_{0.7}O₂ (FIG. 6B), and MS20-Na_{1.1}Ti_{0.2}Mn_{0.7}O₂ (FIG. 6C) in the first 20 cycles under the current density of 10 mA g⁻¹, in accordance with the present disclosure.

FIGS. 7A and 7B are graphs of the discharge specific capacity retention (FIG. 7A) and discharge energy density retention (FIG. 7B) of Na_{1.1}Ti_{0.2}Mn_{0.7}O₂, MS10-Na_{1.1}Ti_{0.2}Mn_{0.7}O₂, and MS20-Na_{1.1}Ti_{0.2}Mn_{0.7}O₂ in the first 20 cycles under the current density of 10 mA g⁻¹, in accordance with the present disclosure.

FIG. 8 is a graph of X-ray diffraction patterns of the stoichiometric Na-excess cation-disordered rock salt cathode (Na_{1.2}Ti_{0.4}Mn_{0.4}O₂), and the over-stoichiometric 10% extra mole ratio Na-excess cation-disordered rock salt cathode (MS10-Na_{1.2}Ti_{0.4}Mn_{0.4}O₂), in accordance with the present disclosure.

FIG. 9 is a graph of the electrochemical performance of Na_{1.2}Ti_{0.4}Mn_{0.4}O₂, and MS10-Na_{1.2}Ti_{0.4}Mn_{0.4}O₂, in the first cycle under the current density of 10 mA g⁻¹, in accordance with the present disclosure.

FIGS. 10A and 10B are graphs of the electrochemical performance of Na_{1.2}Ti_{0.4}Mn_{0.4}O₂ (FIG. 10A), and MS10-Na_{1.2}Ti_{0.4}Mn_{0.4}O₂ (FIG. 10B) in the first 50 cycles under the current density of 10 mA g⁻¹;

FIGS. 11A and 11B are graphs of the discharge specific capacity retention (FIG. 11A) and discharge energy density retention (FIG. 11B) of Na_{1.2}Ti_{0.4}Mn_{0.4}O₂, and MS10-Na_{1.2}Ti_{0.4}Mn_{0.4}O₂ in the first 50 cycles under the current density of 10 mA g⁻¹, in accordance with the present disclosure.

FIG. 12 is a graph of X-ray diffraction patterns of the stoichiometric Na-excess cation-disordered rock salt cathode (Na_{1.3}Ti_{0.6}Mn_{0.1}O₂), and the over-stoichiometric 10% extra mole ratio (hereafter MS10) Na-excess cation-disordered rock salt cathode (MS10-Na_{1.3}Ti_{0.6}Mn_{0.1}O₂), in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present disclosure provides a series of sodium-based cation-disordered rock salts as high-performance Na-ion battery cathode materials. These materials can be realized in a number of compositions and have demonstrated highly promising battery performance results. Such sodium-based cation-disordered rock salts can be readily and successfully applied in a scaled-up device level, these materials can be immediately used in these applications. Thus, these materials can fulfill the need of inexpensive and energy-dense battery technologies.

The present disclosure provides a series of high-performance sodium-based cation-disordered rock salt-type Na-ion battery cathode materials. Currently, battery-based energy storage technologies, including those used in electric vehicles, personal electronics, and stationary battery-based energy storage stations, and the like, strongly rely on Li-ion batteries. Because of the limited natural resource of lithium and sporadic distribution of lithium mines, the dependence on Li-ion batteries poses a strong hinderance on realizing the goal of a net-zero emission economy and total electrification of transportation. The present disclosure provides sodium-based cation-disordered rock salts as high-performance Na-ion battery cathode materials, which can potentially realize low-cost high-performance Na-ion battery technologies.

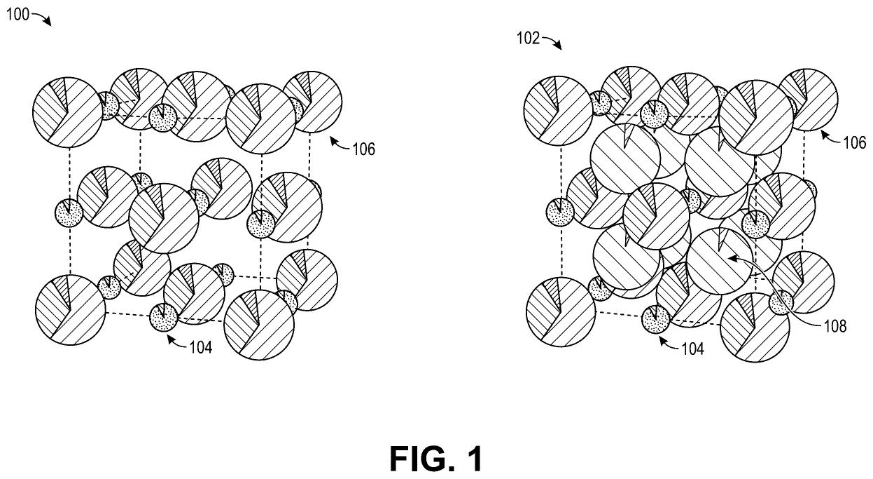

FIG. 1 depicts the likely structure of stoichiometric 100 and over-stoichiometric 102 sodium-based cation-disordered rock salts, in accordance with the present disclosure. The term “rock salt” refers to a NaCl-like crystal structure. The term “cation-disordered” refers to all cations share the same crystallographic site (i.e. Na site in NaCl) without a site preference. In over-stochiometric rock salts, the extra Na ions 108 locate at the interstitial cation sites. The rock salt, for both stoichiometric or over-stoichiometric ones, can exist in an oxide an oxyfluoride form, dependent on the presence of oxygen or oxygen and fluorine 104. In examples, the presence of sodium and/or transition metal 106 is also shown.

An embodiment of a sodium-based cation-disordered rock salt as a cathode of a sodium-ion battery has a chemical formula of:

Naₐ₊ₓM_{b}O_{2-y}F_{y} Formula 1

In Formula 1, “a” is a number no less than about 1. “a” can also be between about 1 and about 1.4, or no more than 1.4. “b” is a number no less than about 0.4, or between about 0.4 and about 1, or between about 0.7 and about 1. “y” is a number greater or equal to 0, or between about 0 and about 1, or no more than 0.7. If “y” equals to 0, the rock salt is an oxide. If “y” is greater than 0, the rock salt is an oxyfluoride. “x” is a degree of over-stoichiometry, and “x” is a number greater or equal to 0, or between about 0 and about 1.0*(a+b), or between about 0 and about 0.4*(a+b), or between about 0 and about 0.2*(a+b).

Furthermore, “M” is a transition metal, including titanium (Ti), vanadium (V), chromium (Cr), manganese (Mn), iron (Fe), cobalt (Co), nickel (Ni), zirconium (Zr), niobium (Nb), molybdenum (Mo), ruthenium (Ru), tantalum (Ta), and tungsten (W), or a combination thereof.

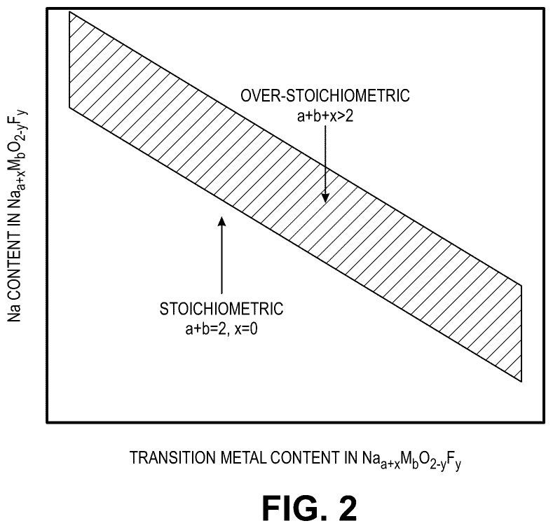

FIG. 2 depicts schematics of the relaxation of site balance constraint for a cation-disordered rock salt and the likely results caused by over-stoichiometry, in accordance with the present disclosure. As described herein, over-stoichiometry refers to the mole ratio between total cations to total anions being greater than 1:1, which allows the relaxation of the site balance constraint of the rock salt structure (i.e. stoichiometric cation-disordered rock salt, 1:1 cation-anion ratio). Relaxation of site balance will allow higher Na content while keeping the same TM (transition metal) content or vice versa, thus offering the possibility of realizing increased energy storage capacity.

Additionally, for the over-stoichiometric sodium-based cation-disordered rock salts, the formula includes an over-stoichiometric sodium ion, such that the sum of “a+x” and “b” equals more than 2. Alternatively, the degree of over-stoichiometry is a number represented by x/(a+b). For example, when using an elemental analysis to measure the molar ratio of Na, M (metal), O, and F, the mole ratio of total cations to total anions is greater than 1:1.

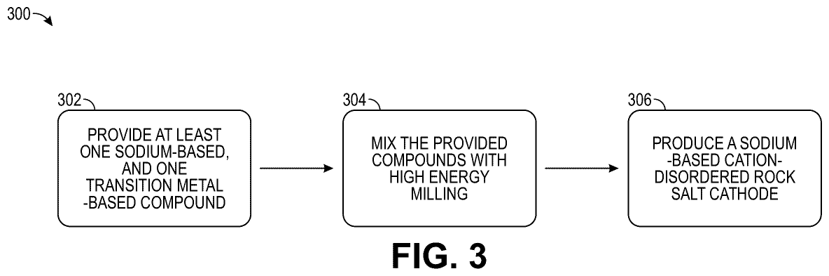

A first exemplary method 300 to synthesize a sodium-based cation-disordered rock salt cathode is shown in FIG. 3. At least one sodium-based and transition metal-based compound is provided in step 302. Example sodium-based compounds include sodium oxide (Na₂O) and sodium fluoride (NaF). Example transition metal compounds are transition metal oxides. The molar ratio of sodium in the sodium compound and transition metal in the transition metal compound is, for example, a number represented by (a+x)/b.

As an example, an embodiment sodium-based cation-disordered rock salt cathode is produced using the first exemplary method 300 by providing a sodium-based compound of Na₂O, and transition metal-based compounds TiO₂, and Mn₂O₃, as discussed in step 302. In step 304 the mixture is mixed with high energy milling to produce a sodium-based cation-disordered rock salt cathode. An example process of high energy milling is to use a high-energy planetary ball mill with a milling rate higher than 300 revolutions per minute (rpm). Examples of sodium-based cation-disordered rock salts include a stoichiometric one, Na_{1.1}Ti_{0.2}Mn_{0.7}O₂, a metastabilized over-stoichiometric one having an extra 10% mole ratio of Na₂O (such as Na_{1.238}Ti_{0.190}Mn_{0.667}O₂, wherein x=0.190, a=1.048, b=0.857, x/(a+b)=0.1), and one having an extra 20% mole ratio of Na₂O (such as Na_{1.364}Ti_{0.182}Mn_{0.636}O₂, wherein x=0.364, a=1.000, b=0.818, x/(a+b)=0.2). In examples, the metastable over-stoichiometric salt is a salt that is in a state of kinetic stability, for example, it is not in its most energetically favorable state but can persist due to a lack of nucleation or crystallization triggers.

In some embodiments, sodium-based cation-disordered rock salt cathodes produced by method 300 are selected from a group comprising of Na_{1.}Ti_{0.2}Mn_{0.7}O₂, Na_{1.238}Ti_{0.190}Mn_{0.667}O₂ (MS10-Na_{1.1}Ti_{0.2}Mn_{0.7}O₂), Na_{1.364}Ti_{0.182}Mn_{0.636}O₂ (MS20-Na_{1.1}Ti_{0.2}Mn_{0.7}O₂), Na_{1.2}Ti_{0.4}Mn_{0.4}O₂, Na_{1.333}Ti_{0.381}Mn_{0.381}O₂ (MS10-Na_{1.2}Ti_{0.4}Mn_{0.4}O₂), Na_{1.3}Ti_{0.6}Mn_{0.1}O₂, and Na_{1.429}Ti_{0.571}Mn_{0.095}O₂ (MS10-Na_{1.3}Ti_{0.6}Mn_{0.1}O₂). The exemplary cathodes produced 103 include over-stoichiometric sodium having extra mole ratio of sodium in an amount of between about greater than 0% and about 100% sodium, or between about 10% and about 100% sodium, or between about 10% and about 50%, or between about 10% and about 20%. This can be referred to as an over-stoichiometry amount.

Sodium-based transition metal-based cation-disordered rock salt cathodes can be directly applied into a sodium-ion battery to be utilized alongside any desired anodes. In an embodiment, the produced sodium-based cation-disordered rock salt cathode is mixed with conducting additives (for example, acetylene black), and binding additives (for example, polyvinylidene fluoride).

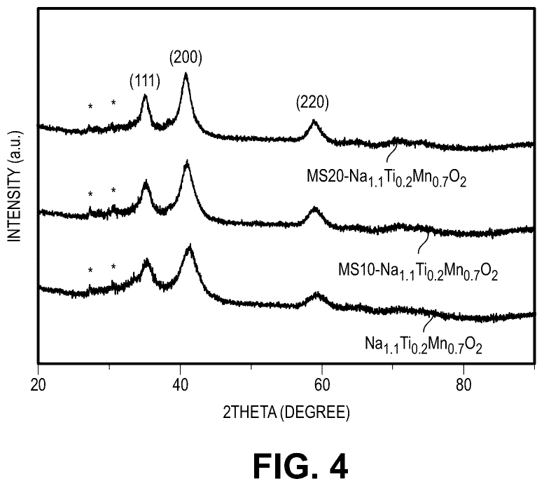

Exemplary embodiments of sodium cation-disordered rock salt cathodes produced under method 300 show electrochemical properties that are further demonstrated under the following examples with measured data provided in the graphs shown in FIGS. 4 to 12.

In an example, a stoichiometrically balanced sodium-based manganese-based cation-disordered rock salt having the chemical formula of Na_{1.1}Ti_{0.2}Mn_{0.7}O₂ was synthesized as a comparative example, and two over-stoichiometric sodium-based manganese-based cation-disordered rock salts having the chemical formula of Na_{1.238}Ti_{0.190}Mn_{0.667}O₂, which includes 10% extra mole ratio of sodium (hereinafter as “MS10”), and Na_{1.364}Ti_{0.182}Mn_{0.636}O₂, which includes 20% extra mole ratio of sodium (hereinafter as “MS20”) have been synthesized using the described method.

Exemplary over-stoichiometric sodium-based cation-disordered rock salt cathodes of Na_{1.238}Ti_{0.190}Mn_{0.667}O₂ (MS10-Na_{1.1}Ti_{0.2}Mn_{0.7}O₂), and Na_{1.364}Ti_{0.182}Mn_{0.636}O₂ (MS20-Na_{1.1}Ti_{0.2}Mn_{0.7}O₂), were synthesized through the room-temperature, or from about 20° C. to about 30° C., mechano-synthesis method described in the first exemplary method 300. After adding an extra amount of Na₂O (such as an extra 0% mole ratio of Na₂O to obtain stoichiometric Na_{1.1}Ti_{0.2}Mn_{0.7}O₂, an extra 10% mole ratio of Na₂O to obtain Na_{1.238}Ti_{0.190}Mn_{0.667}O₂ (MS10-Na_{1.1}Ti_{0.2}Mn_{0.7}O₂), or an extra 20% mole ratio of Na₂O to obtain Na_{1.364}Ti_{0.182}Mn_{0.636}O₂ (MS20-Na_{1.1}Ti_{0.2}Mn_{0.7}O₂)) compared to the stoichiometry used to synthesize Na_{1.1}Ti_{0.2}Mn_{0.7}O₂, the compounds were dry-mixed and then milled in a zirconia jar with 5 mm zirconia balls at 450 rpm for 24 hours in a planetary ball mill to produce sodium-based cation-disordered rock salts.

Tests of the exemplary sodium-based cation-disordered rock salt cathodes MS10-Na_{1.1}Ti_{0.2}Mn_{0.7}O₂ and MS20-Na_{1.1}Ti_{0.2}Mn_{0.7}O₂, with the comparative stoichiometric Na_{1.1}Ti_{0.2}Mn_{0.7}O₂, demonstrate the performance of these sodium-based cation-disordered rock slats when applied as the cathode in sodium ion batteries.

FIG. 4 shows the X-ray diffraction patterns of the over-stoichiometric MS10-Na_{1.1}Ti_{0.2}Mn_{0.7}O₂ cation-disordered rock salt cathode and the over-stoichiometric MS20-Na_{1.1}Ti_{0.2}Mn_{0.7}O₂ cation-disordered rock salt cathode as compared to the baseline of the stoichiometric Na_{1.1}Ti_{0.2}Mn_{0.7}O₂ cation-disordered rock salt cathode. Both MS10-Na_{1.1}Ti_{0.2}Mn_{0.7}O₂ and MS20-Na_{1.1}Ti_{0.2}Mn_{0.7}O₂ cation-disordered rock salt demonstrates typical rock salt-like XRD pattern. The broader peaks of Na_{1.1}Ti_{0.2}Mn_{0.7}O₂, MS10-Na_{1.1}Ti_{0.2}Mn_{0.7}O₂, and MS20-Na_{1.1}Ti_{0.2}Mn_{0.7}O₂ are due to their smaller particle size. In FIG. 4, asterisks mark the diffraction peaks of the air-tight holder, in which Na_{1.1}Ti_{0.2}Mn_{0.7}O₂, MS10-Na_{1.1}Ti_{0.2}Mn_{0.7}O₂ and MS20-Na_{1.1}Ti_{0.2}Mn_{0.7}O₂ are held during X-ray diffraction measurements.

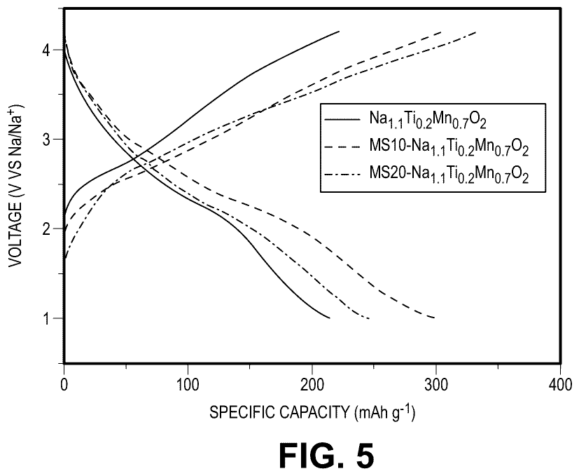

FIG. 5 shows a graph of the comparative electrochemical performance of the stoichiometric Na_{1.1}Ti_{0.2}Mn_{0.7}O₂ compared to the over-stoichiometric MS10-Na_{1.1}Ti_{0.2}Mn_{0.7}O₂ and the MS20-Na_{1.1}Ti_{0.2}Mn_{0.7}O₂ in the first cycle at a rate of 10 mA g⁻¹. The graph shows significant improvement of specific capacity of over-stoichiometric MS10-Na_{1.1}Ti_{0.2}Mn_{0.7}O₂ and MS20-Na_{1.1}Ti_{0.2}Mn_{0.7}O₂ compared to stoichiometric Na_{1.1}Ti_{0.2}Mn_{0.7}O₂.

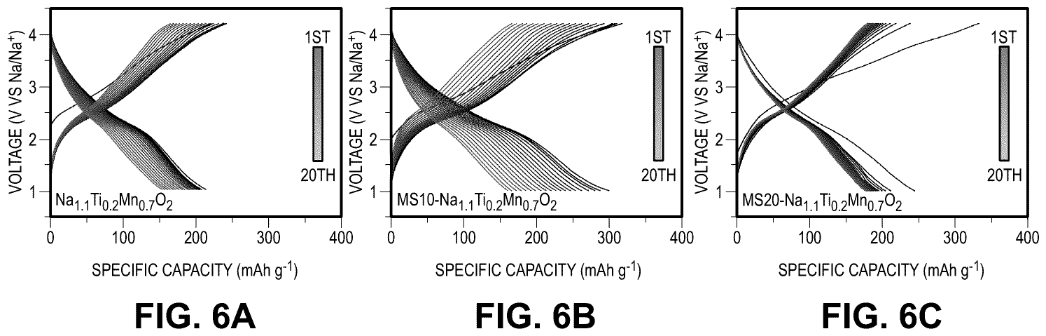

FIGS. 6A, 6B, and 6C show the measured electrochemical performances of the stoichiometric Na_{1.1}Ti_{0.2}Mn_{0.7}O₂ cathode (FIG. 6A) compared to the over-stoichiometric MS10-Na_{1.1}Ti_{0.2}Mn_{0.7}O₂ cathode (FIG. 6B) and the MS20-Na_{1.1}Ti_{0.2}Mn_{0.7}O₂ cathode (FIG. 6C) in the first 20 cycles under the current density of 10 mA g⁻¹. The charts show that the MS10-Na_{1.1}Ti_{0.2}Mn_{0.7}O₂ and MS20-Na_{1.1}Ti_{0.2}Mn_{0.7}O₂ cathodes both had increases in specific capacity as compared to the stoichiometric Na_{1.1}Ti_{0.2}Mn_{0.7}O₂ cathode.

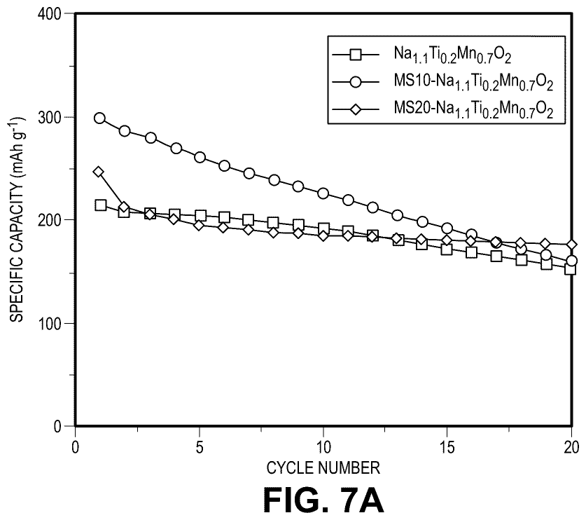

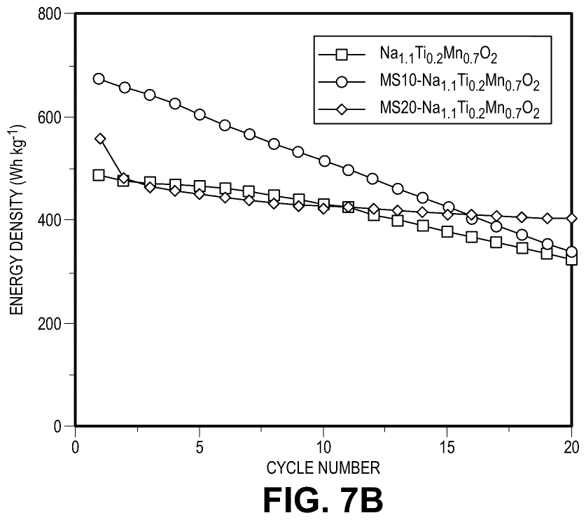

FIG. 7A shows the measured discharge specific capacity retention of the stoichiometric Na_{1.1}Ti_{0.2}Mn_{0.7}O₂ cathode compared to the over-stoichiometric MS10-Na_{1.1}Ti_{0.2}Mn_{0.7}O₂ cathode and the MS20-Na_{1.1}Ti_{0.2}Mn_{0.7}O₂ cathode under the current density of 10 mA g⁻¹. The graphs show that the specific capacities of MS10-Na_{1.1}Ti_{0.2}Mn_{0.7}O₂ cathode and MS20-Na_{1.1}Ti_{0.2}Mn_{0.7}O₂ cathode are significantly higher than the stoichiometric Na_{1.1}Ti_{0.2}Mn_{0.7}O₂ cathode.

FIG. 7B shows the discharge energy density retention of the stoichiometric Na_{1.1}Ti_{0.2}Mn_{0.7}O₂ cathode compared to the over-stoichiometric MS10-Na_{1.1}Ti_{0.2}Mn_{0.7}O₂ cathode and the MS20-Na_{1.1}Ti_{0.2}Mn_{0.7}O₂ cathode under a current density of 10 mA g⁻¹. It can be seen that the over-stoichiometric MS10-Na_{1.1}Ti_{0.2}Mn_{0.7}O₂ and MS20-Na_{1.1}Ti_{0.2}Mn_{0.7}O₂ cathodes present higher discharge energy densities than the stoichiometric Na_{1.1}Ti_{0.2}Mn_{0.7}O₂ cathode.

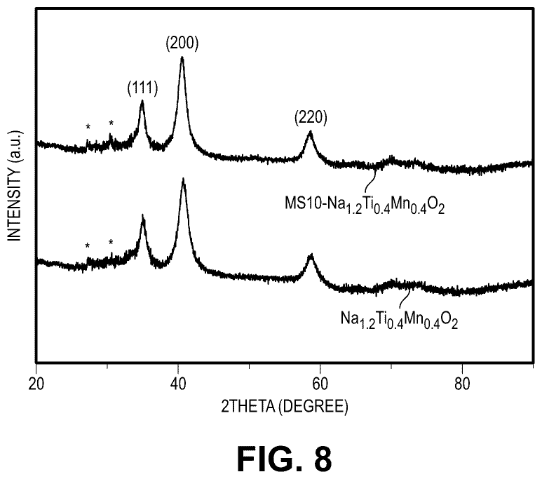

In a further example, a stoichiometric sodium-based cation-disordered rock salt with a higher sodium content Na_{1.2}Ti_{0.4}Mn_{0.4}O₂ and over-stoichiometric MS10-Na_{1.2}Ti_{0.4}Mn_{0.4}O₂ can be synthesized using the exemplary method 300. FIG. 8 shows the X-ray diffraction patterns of each sample. In FIG. 8, asterisks mark the diffraction peaks of the air-tight holder, in which Na_{1.2}Ti_{0.4}Mn_{0.4}O₂ and MS10-Na_{1.2}Ti_{0.4}Mn_{0.4}O₂ are held during X-ray diffraction measurements.

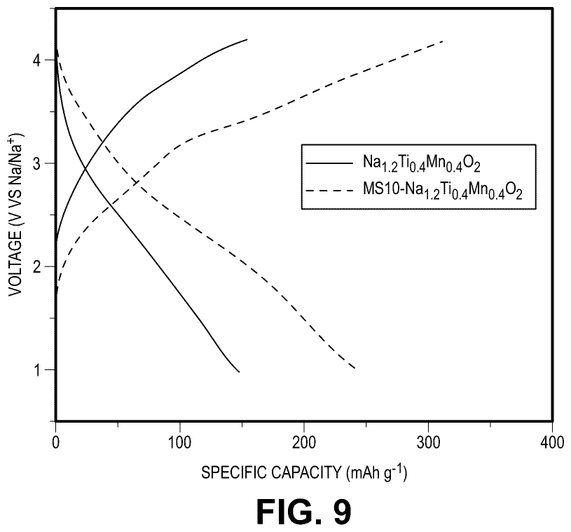

FIG. 9 shows the electrochemical performance in the first cycle of stoichiometric Na_{1.2}Ti_{0.4}Mn_{0.4}O₂ and over-stoichiometric MS10-Na_{1.2}Ti_{0.4}Mn_{0.4}O₂ at a rate of 10 mA g⁻¹. The charts show that the MS10-Na_{1.2}Ti_{0.4}Mn_{0.4}O₂ cathode had increases in specific capacity as compared to the stoichiometric Na_{1.2}Ti_{0.4}Mn_{0.4}O₂ cathode.

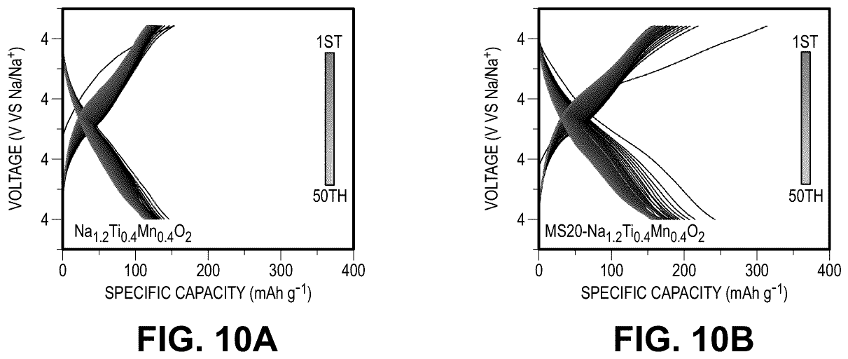

FIGS. 10A and 10B show the measured electrochemical performances of the stoichiometric Na_{1.2}Ti_{0.4}Mn_{0.4}O₂ cathode (FIG. 10A) compared to the over-stoichiometric MS10-Na_{1.2}Ti_{0.4}Mn_{0.4}O₂ cathode (FIG. 10B) in the first 50 cycles under the current density of 10 mA g⁻¹. The charts show that the MS10-Na_{1.2}Ti_{0.4}Mn_{0.4}O₂ cathode had increases in specific capacity as compared to the stoichiometric Na_{1.2}Ti_{0.4}Mn_{0.4}O₂ cathode.

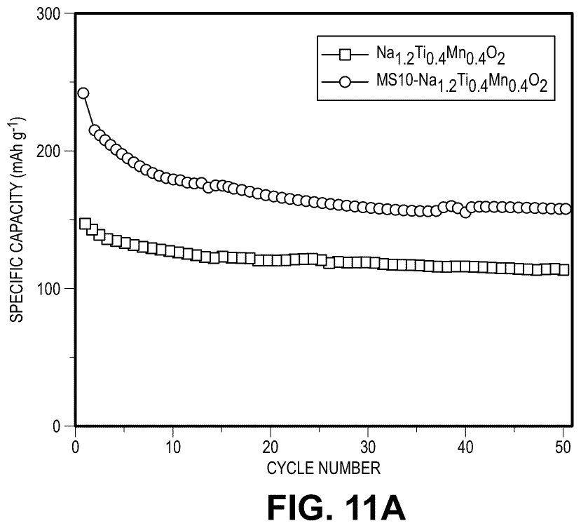

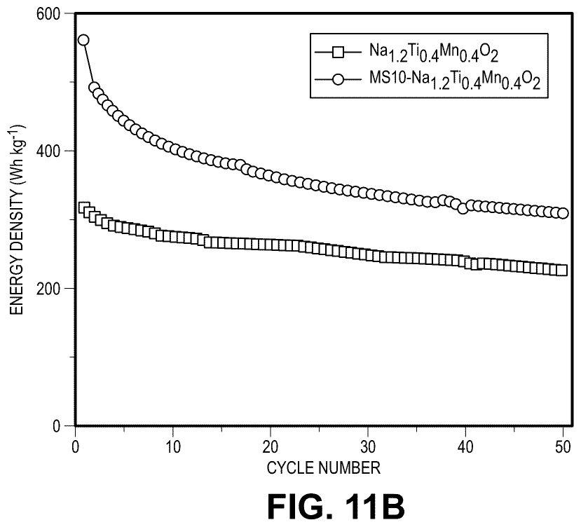

FIG. 11A show the measured discharge specific capacity retention of the stoichiometric Na_{1.2}Ti_{0.4}Mn_{0.4}O₂ cathode compared to the over-stoichiometric MS10-Na_{1.2}Ti_{0.4}Mn_{0.4}O₂ cathode under the current density of 10 mA g⁻¹. The graphs show that the specific capacities of MS10-Na_{1.2}Ti_{0.4}Mn_{0.4}O₂ cathode are significantly higher than the stoichiometric Na_{1.2}Ti_{0.4}Mn_{0.4}O₂ cathode.

FIG. 11B show the discharge energy density retention of the stoichiometric Na_{1.2}Ti_{0.4}Mn_{0.4}O₂ cathode compared to the over-stoichiometric MS10-Na_{1.2}Ti_{0.4}Mn_{0.4}O₂ cathode under a current density of 10 mA g⁻¹. It can be seen that the over-stoichiometric MS10-Na_{1.2}Ti_{0.4}Mn_{0.4}O₂ cathode presents higher discharge energy densities than the stoichiometric Na_{1.2}Ti_{0.4}Mn_{0.4}O₂ cathode.

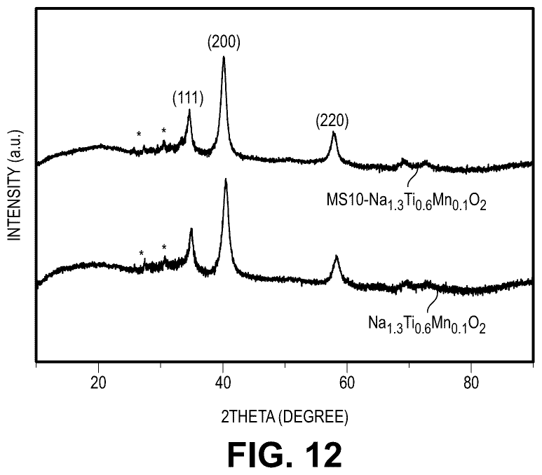

In a further example, a stoichiometric sodium-based cation-disordered rock salt with a higher sodium content Na_{1.3}Ti_{0.6}Mn_{0.1}O₂ and over-stoichiometric MS10-Na_{1.3}Ti_{0.6}Mn_{0.1}O₂ can be synthesized using the exemplary method 300. FIG. 12 shows the X-ray diffraction patterns of each sample. In FIG. 12, asterisks mark the diffraction peaks of the air-tight holder, in which Na_{1.3}Ti_{0.6}Mn_{0.1}O₂ and MS10-Na_{1.3}Ti_{0.6}Mn_{0.1}O₂ are held during X-ray diffraction measurements.

The method of synthesizing sodium-based cation-disordered rock salts is seen to be applicable to different stoichiometries, as shown by the graphs of the measured data of each of the sample, such as the Na_{1.1}Ti_{0.2}Mn_{0.7}O₂, MS10-Na_{1.1}Ti_{0.2}Mn_{0.7}O₂, MS20-Na_{1.1}Ti_{0.2}Mn_{0.7}O₂, Na_{1.2}Ti_{0.4}Mn_{0.4}O₂, MS10-Na_{1.2}Ti_{0.4}Mn_{0.4}O₂, Na_{1.3}Ti_{0.6}Mn_{0.1}O₂, and MS10-Na_{1.3}Ti_{0.6}Mn_{0.1}O₂. The performance of the over-stoichiometric sodium-based transition metal-based cation-disordered rock salt cathodes are shown to be systematically higher than the respective stoichiometrically balanced sodium-based transition metal-based cation-disordered rock salts. The testing data of sodium-based transition metal-based cation-disordered rock salt cathodes are shown to have promising applications in sodium ion batteries.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having.” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A cathode for an electrochemical device, comprising:
a sodium-based cation-disordered rock salt comprising a transition metal.

2. The cathode for an electrochemical device of claim 1, wherein the sodium-based cation-disordered rock salt has a chemical formula of:
Naₐ₊ₓM_{b}O_{2-y}F_{y}; and wherein:
a≥1, 0≤x≤1.0*(a+b), y≥0, and M comprises a transition metal selected from the group consisting of titanium, vanadium, chromium, manganese, iron, cobalt, nickel, zirconium, niobium, molybdenum, ruthenium, tantalum, and tungsten.

3. The cathode for an electrochemical device of claim 1, wherein the sodium-based cation-disordered rock salt can either be stoichiometric (x=0 and a+b=2) or over-stoichiometric (a+b+x>2 and x>0).

4. The cathode for an electrochemical device of claim 3, wherein the sodium-based cation-disordered rock salt is over-stoichiometric and the over-stoichiometry amount of sodium comprises an extra mole ratio of sodium of between 0% and about 100%.

5. The cathode for an electrochemical device of claim 1, wherein the sodium-based cation-disordered rock salt is selected from the group consisting of Na_{1.1}Ti_{0.2}Mn_{0.7}O₂, MS10-Na_{1.1}Ti_{0.2}Mn_{0.7}O₂, MS20-Na_{1.1}Ti_{0.2}Mn_{0.7}O₂, Na_{1.2}Ti_{0.4}Mn_{0.4}O₂, MS10-Na_{1.2}Ti_{0.4}Mn_{0.4}O₂, Na_{1.3}Ti_{0.6}Mn_{0.1}O₂, and MS10- Na_{1.3}Ti_{0.6}Mn_{0.1}O₂.

6. The cathode for an electrochemical device of claim 1, wherein the sodium-based cation-disordered rock salt is in a metastable state.

7. A sodium-ion battery, comprising:
a cathode having a cation-disordered rock salt comprising sodium and at least one transition metal; and
an anode; and wherein:
the cation-disordered rock salt is over-stoichiometric.

8. The sodium-ion battery of claim 7, wherein the cation-disordered rock salt has a chemical formula of
Naₐ₊ₓM_{b}O_{2-y}F_{y}; wherein:
a≥1, 0≤x≤1.0*(a+b), y≥0, and M comprises a transition metal selected from the group consisting of titanium, vanadium, chromium, manganese, iron, cobalt, nickel, zirconium, niobium, molybdenum, ruthenium, tantalum, and tungsten.

9. The sodium-ion battery of claim 8, wherein the cation-disordered rock salt can either be stoichiometric (x=0) or over-stoichiometric (x>0).

10. The sodium-ion battery of claim 9, wherein the cation-disordered rock salt is over-stoichiometric and the over-stoichiometry amount of sodium comprises an extra mole ratio of sodium of between 0% and about 100%.

11. The sodium-ion battery of claim 7, wherein the cation-disordered rock salt is selected from the group consisting of Na_{1.1}Ti_{0.2}Mn_{0.7}O₂, MS10-Na_{1.1}Ti_{0.2}Mn_{0.7}O₂, MS20-Na_{1.1}Ti_{0.2}Mn_{0.7}O₂, Na_{1.2}Ti_{0.4}Mn_{0.4}O₂, MS10-Na_{1.2}Ti_{0.4}Mn_{0.4}O₂, Na_{1.3}Ti_{0.6}Mn_{0.1}O₂, and MS10-Na_{1.3}Ti_{0.6}Mn_{0.1}O₂.

12. The sodium-ion battery of claim 7, wherein the cation-disordered rock salt is in a metastable state.

13. A method of synthesizing a cation-disordered rock salt cathode for a sodium-ion battery comprising:
providing at least one compound comprising sodium;
providing at least one compound comprising a transition metal;
mixing the compound comprising sodium and the compound comprising a transition metal; and
producing a cation-disordered rock salt cathode.

14. The method of claim 13, wherein the mixing is performed with a mechanochemical method.

15. The method of claim 13, wherein the mixing is performed with a planetary ball mill operating at or above 300 rpm.

16. The method of claim 13, wherein the cation-disordered rock salt cathode has a chemical formula of
Naₐ₊ₓM_{b}O_{2-y}F_{y}; and wherein:
a≥1, 0≤x≤1.0*(a+b), y≥0, and M comprises a transition metal selected from the group consisting of titanium, vanadium, chromium, manganese, iron, cobalt, nickel, zirconium, niobium, molybdenum, ruthenium, tantalum, and tungsten.

17. The method of claim 16, wherein the cation-disordered rock salt can either be stoichiometric (x=0) or over-stoichiometric (x>0).

18. The method of claim 13, wherein the cation-disordered rock salt is over-stoichiometric and the over-stoichiometry amount of sodium comprises an extra mole ratio of sodium of between 0% and about 100%.

19. The method of claim 18, wherein the stoichiometric cation-disordered rock salt has a mole ratio of total cations to total anions being equal to 1:1, and the over-stoichiometric sodium-based cation-disordered rock salt has a mole ratio of total cations to total anions being greater than 1:1.

20. The method of claim 13, further comprising incorporating the cation-disordered rock salt cathode into a sodium-ion battery.
